(19) United States
(12) Patent Application Publication
(10) Pub. No.: US 2020/0368862 A1
(43) Pub. Date: Nov. 26, 2020

(54) CONNECTING DEVICE AND CONNECTING METHOD

(71) Applicant: KAWASAKI JUKOGYO KABUSHIKI KAISHA, Kobe-shi (JP)

(72) Inventors: Kazunori HIRATA, Osaka (JP); Takeshi HASHIMOTO, Kakogawa-shi (JP); Takayuki ISHIZAKI, Kakogawa-shi (JP); Keita SASAKI, Akashi-shi (JP)

(73) Assignee: KAWASAKI JUKOGYO KABUSHIKI KAISHA, Kobe-shi (JP)

(21) Appl. No.: 16/991,053

(22) Filed: Aug. 12, 2020

Related U.S. Application Data
(63) Continuation of application No. PCT/JP2019/003562, filed on Feb. 1, 2019.

(30) Foreign Application Priority Data
Feb. 14, 2018 (JP) 2018-023665

(51) Int. Cl. B23P 19/04; B25J 15/06; B25J 9/00; B25J 9/16; H01R 43/26

(52) U.S. Cl. CPC B23P 19/04; B25J 15/06; H01R 43/26; B25J 9/1664; B25J 9/0087

(57) ABSTRACT

The present disclosure provides a connecting device and a connecting method which securely connect a workpiece to a connector. The connecting device includes a holding part configured to hold a workpiece, an abutting part against which the workpiece is abutted, and processing circuitry configured to control the holding part to hold the workpiece, control movement of the holding part, and control movement of the abutting part. The processing circuitry controls the holding part and the abutting part so that the holding part holds the workpiece abutted against an abutting position of the abutting part and so that the workpiece is connected to the connector.

### CROSS REFERENCE TO RELATED APPLICATIONS

This application is a bypass continuation of and claims priority to PCT/JP2019/003562, filed on Feb. 1, 2019, which claims priority to JP 2018-023665, filed on Feb. 14, 2018, both of which are incorporated by reference in their entirety.

### TECHNICAL FIELD

The present disclosure relates to a connecting device and a connecting method which connect a workpiece to a given position.

### BACKGROUND

Conventionally, configurations of connecting devices are disclosed, in which a cable is gripped as a workpiece, the gripped cable is positioned, and the positioned cable is connected to a connector on a substrate. A robot grips the cable by using a hand, and the gripping position is moved while sliding the hand along the cable to move the gripping part of the cable by the hand to an imaging position. The gripping position of the cable by the hand is imaged at the imaging position, and whether the hand reaches a target position is detected based on the captured image. If the hand does not reach the target position, the hand corrects the position and whether the hand reaches the target position is again detected. If it is confirmed that the hand reaches the target position, the hand moves to connect the cable to the connector.

However, such a connecting device detects whether the gripping position of the cable reaches the target position, based on the captured image. Thus, configurations of an imaging means and a system which detects whether the hand reaches the target position based on the image captured by the imaging means are required. Therefore, the configuration of the device may become complicated and the manufacturing cost of the device may increase.

### SUMMARY

A connecting device according to the present disclosure is a connecting device configured to connect a workpiece to a connector, wherein the workpiece is fixed at a base-end part of the workpiece. The connecting device includes a holding part configured to hold the workpiece, an abutting part against which the workpiece is abutted, and processing circuitry configured to control the holding part to hold the workpiece, control movement of the holding part, and control movement of the abutting part. The processing circuitry controls the holding part and the abutting part so that the holding part holds the workpiece abutted against an abutting position of the abutting part and so that the workpiece is connected to the connector.

### BRIEF DESCRIPTION OF THE DRAWINGS

FIG. 1 is a perspective view of a connecting device according to the present disclosure.

FIG. 2 is a schematic front view of the connecting device of FIG. 1.

FIG. 3 is a perspective view illustrating an area around a holding part of the connecting device of FIG. 1.

FIG. 4 is a perspective view illustrating an area around an abutting part of the connecting device of FIG. 1.

FIG. 5 is a block diagram illustrating a configuration of a controller of the connecting device of FIG. 1.

FIG. 6 is a flowchart illustrating a process when connecting a cable to a connector by the connecting device of FIG. 1.

FIG. 7 is a perspective view illustrating a state where the holding part and the cable are close to each other in order for the holding part to hold the cable, when a connection is performed by the connecting device of FIG. 1.

FIG. 8 is a perspective view illustrating a state where the holding part contacts and holds the cable, when the connection is performed by the connecting device of FIG. 1.

FIG. 9 is a perspective view of a periphery of the holding part and the abutting part, illustrating a state where the holding part holding the cable approaches the abutting part, when the connection is performed by the connecting device of FIG. 1.

FIG. 10 is a perspective view of the periphery of the holding part and the abutting part, illustrating a state where the cable is abutted to an abutting position of the abutting part, when the connection is performed by the connecting device of FIG. 1.

FIG. 11 is a perspective view of the periphery of the holding part and the abutting part, illustrating a state where the cable is held by the holding part after the cable is abutted to the abutting position of the abutting part, when the connection is performed by the connecting device of FIG. 1.

FIG. 12 is a perspective view of the periphery of the holding part and the abutting part, illustrating a state where a pressing part of the holding part is lowered to press a tip-end part of the cable after the cable is abutted to the abutting position of the abutting part, when the connection is performed by the connecting device of FIG. 1.

FIG. 13 is a perspective view of the periphery of the holding part and the abutting part, illustrating a state where a lid part of a lock mechanism is moved into a closed state after the cable is connected to a connecting position, when the connection is performed by the connecting device of FIG. 1.

### DETAILED DESCRIPTION OF THE DRAWINGS

Hereinafter, a connecting device and a connecting method according to the present disclosure are described with reference to the accompanying drawings.

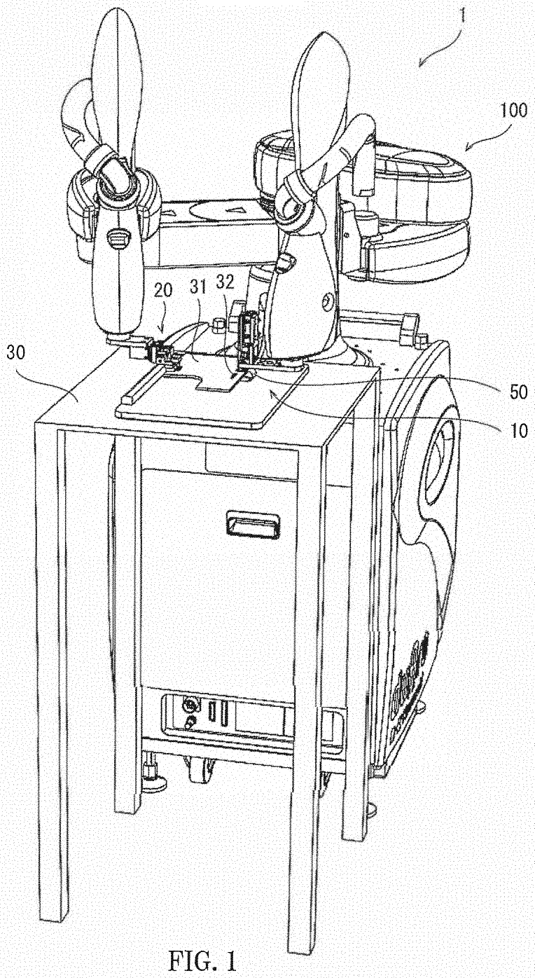

FIG. 1 is a perspective view of a connecting device 1 according to the present disclosure.

As illustrated in FIG. 1, the connecting device 1 includes a connecting device main body 100 and a table 30 where a substrate is placed.

In a state illustrated in FIG. 1, a substrate 31 is placed on the table 30. The substrate 31 is provided with a connector 32. A cable 50 is connectable to a connecting position of the connector 32, as a workpiece.

The connecting device main body 100 includes a holding part 10 which can hold the cable 50 as the workpiece, and an abutting part 20 which performs positioning of the cable 50 by abutting the cable 50 held by the holding part 10. The cable 50 may be formed in a foil-like shape. Moreover, since the cable 50 is made of a thin and flexible material, it has flexibility, and as illustrated in FIG. 1, it is bendable so that a part thereof becomes in an arc shape. The cable 50 as a workpiece is a so-called FFC (Flexible Flat Cable). Moreover, a connecting part is the connector 32 provided to the substrate 31.

The cable 50 may be formed in an elongated shape. The cable 50 is provided with a tip-end part and a base-end part, and is connected to the substrate 31 at the base-end part. Here, the part of the cable 50 on the side connected to the connecting part is referred to as “the tip-end part,” and the part of the cable 50 on the side connected to the substrate 31 is referred to as “the base-end part.” As described above, the cable 50 is provided so that the base-end part is fixed to a given position and is connected to a position of the substrate 31 close to the connector 32. Moreover, the cable 50 is formed in the elongated shape in a direction from the base-end part to the tip-end part. The connecting device main body 100 is configured as a robot, and the holding part 10 and the abutting part 20 are each configured as a hand of the robot.

The holding part 10 holds the cable 50 by suction. The holding part 10 is provided with a suction part 11 which holds the cable 50 by suction. A plurality of suction openings are formed in the suction part 11 of the holding part 10 which contacts the cable. By performing suction through the suction openings while the suction part 11 of the holding part 10 contacts the cable 50, the holding part 10 can hold the cable 50 by suction.

The abutting part 20 is a member against which the cable 50 held by the holding part 10 is abutted. By abutting the cable 50 against an abutting position of the abutting part 20, positioning of the cable 50 is performed. Next, a configuration of the connecting device main body 100 is described.

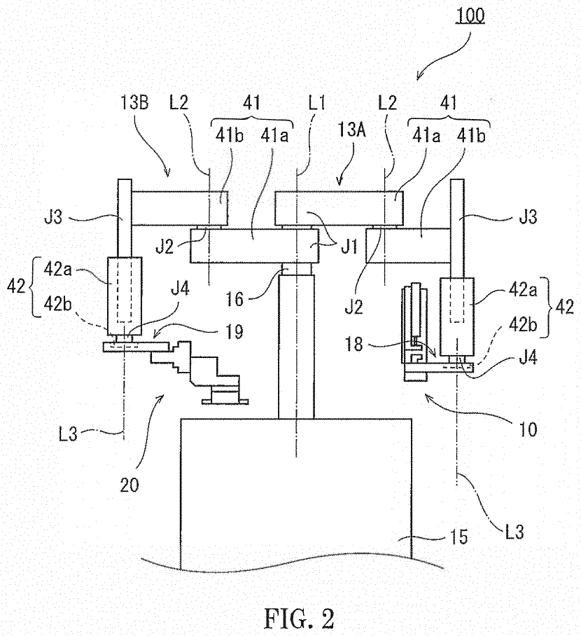

A schematic front view of the connecting device main body 100 is illustrated in FIG. 2. As illustrated in FIG. 2, the connecting device main body 100 is comprised of a horizontal articulated dual-arm robot having a pair of robotic arms 13A and 13B.

The connecting device main body 100 is provided with a first robotic arm (first arm) 13A and a second robotic arm (second arm) 13B. A first holding part 18 is provided to a tip-end part of the first robotic arm 13A. A second holding part 19 is provided to a tip-end part of the second robotic arm 13B. Below, when not distinguishing the first robotic arm 13A and the second robotic arm 13B, they may simply be referred to as “the robotic arm(s) 13.” The connecting device main body 100 is provided with a controller 14 and a vacuum generator.

The controller 14 is provided, for example, inside a support 15 of the connecting device main body 100. However, it may be provided inside the robotic arm 13, without being limited to the configuration described above. Alternatively, it may be provided in other vacant spaces.

The vacuum generator may be, for example, a vacuum pump, CONVUM®, etc. The vacuum generator is also provided, for example, inside the support 15, similar to the controller 14. However, the vacuum generator may be provided, for example, to other locations, such as inside the robotic arm 13, without being limited to the configuration described above. The vacuum generator is connected with the suction openings of the holding part 10 (described later) through piping. The piping is provided, for example, with an on-off valve, and the piping is opened and closed by the on-off valve. The operation of the vacuum generator, and opening and closing of the on-off valve are controlled by the controller 14.

The first robotic arm 13A moves the first holding part 18 within a given operating range. Moreover, the second robotic arm 13B moves the second holding part 19 within a given operating range. The robotic arms 13 each is, for example, a horizontal articulated robotic arm, and includes an arm part 41 and a wrist part 42. Moreover, the first robotic arm 13A and the second robotic arm 13B can operate independently or dependently. The first holding part 18 and the second holding part 19 each grips a hand part with a function.

The connecting device main body 100 is provided with the support 15 and a base shaft 16 extending vertically upward from the support 15. The base shaft 16 is rotatably attached to the support 15.

The arm part 41 is attached to the base shaft 16 so as to extend horizontally. The arm part 41 is attached to be rotatable centering on the base shaft 16.

The arm part 41 includes a first link 41a and a second link 41b. The first link 41a and the second link 41b are supported to be rotatable horizontally to each other. The first robotic arm 13A and the second robotic arm 13B are each connected with the base shaft 16 through the arm part 41.

The arm part 41 positions the wrist part 42 attached to the tip-end part of each of the first robotic arm 13A and the second robotic arm 13B at an arbitrary position within the operating range.

The first link 41a is coupled at its base-end part to the base shaft 16 of the support 15 through a rotary joint J1, and is rotatable about a rotation axis L1 which passes through the axial center of the base shaft 16. The second link 41b is coupled to a tip-end part of the first link 41a through a rotary joint J2, and is rotatable about a rotation axis L2 which is defined at the tip-end part of the first link 41a.

The wrist part 42 changes a mechanism attached to a tip end thereof into an arbitrary posture. The wrist part 42 includes an elevating part 42a and a rotating part 42b. The elevating part 42a is coupled to a tip-end part of the second link 41b through a linear-motion joint J3, and is ascendable and descendable with respect to the second link 41b. The rotating part 42b is coupled to a lower end part of the elevating part 42a through a rotary joint J4, and is rotatable about a rotation axis L3 which is defined at a lower end of the elevating part 42a.

In an exemplary implementation, the rotation axes L1-L3 are parallel to each other, and, for example, they extend vertically. Moreover, the extending direction of the rotation axes L1-L3 and the elevating direction of the elevating part 42a are parallel to each other.

Each arm 13 is provided with driving servomotors and encoders which detect rotation angles of the servomotors so as to correspond to the joints J1-J4. Moreover, the rotation axis L1 of the first robotic arm 13A and the rotation axis L1 of the second robotic arm 13B are coaxial, and the first link 41a of the first robotic arm 13A and the first link 41a of the second robotic arm 13B are provided with a height difference therebetween.

Next, hands which can be gripped by the first holding part 18 and the second holding part 19 are described. The first holding part 18 holds the holding part 10 as the hand. Moreover, the second holding part 19 holds the abutting part 20 as the hand.

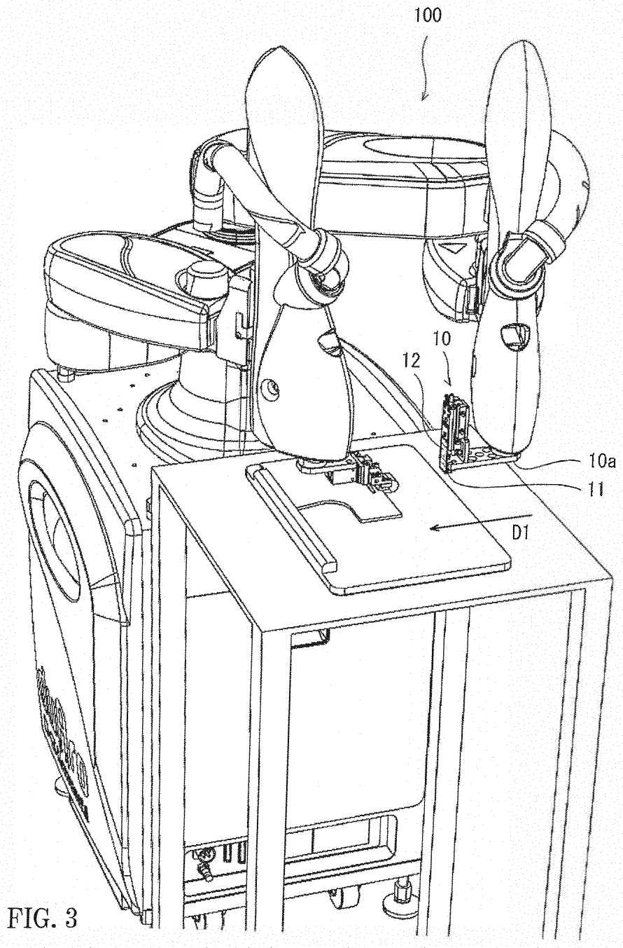

Next, a configuration of the holding part 10 is described. A perspective view of a periphery part of the holding part 10 is illustrated in FIG. 3.

The holding part 10 is provided with the suction part 11. The plurality of suction openings are formed in the suction part 11. The suction openings are formed in a tip-end part of the suction part 11 on the side which contacts the cable, and are formed in the suction part 11 downwardly in the gravity direction.

The suction openings of the suction part 11 are connected with the vacuum generator through the piping described above, and are possible to suck air from the suction openings. By contacting the suction openings to the cable while sucking air from the suction openings of the suction part 11 of the holding part 10, the suction part 11 sucks and holds the cable. The holding part 10 is gripped by the first holding part 18, and is movable within the given operating range by driving the first robotic arm 13A.

The holding part 10 is also provided with a pressing part 12 attached to a tip-end part thereof in a D1 direction from an attaching part 10a rotatably attached to the rotating part 42b of the wrist part 42 to the suction part 11 so that it is movable in the gravity direction. The pressing part 12 is formed in a plate-like shape. Therefore, the pressing part 12 is possible to press in the gravity direction the tip-end part of the cable in the D1 direction held by the holding part 10.

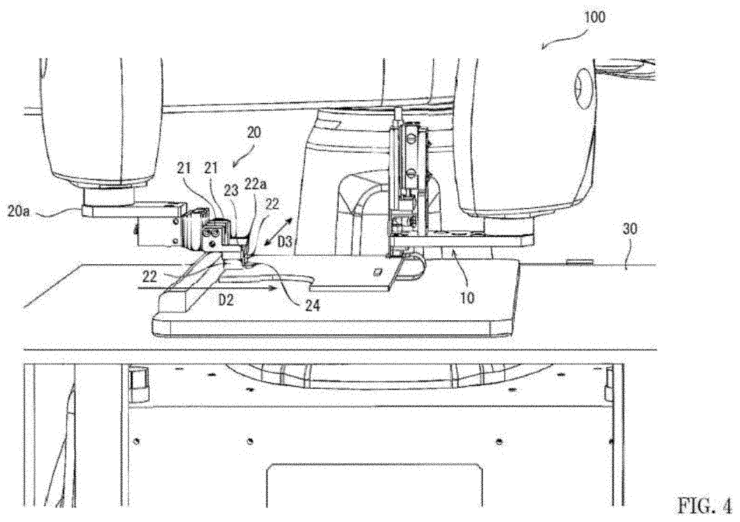

Next, a configuration of the abutting part 20 is described. An enlarged perspective view of a periphery part of the abutting part 20 is illustrated in FIG. 4. The abutting part 20 is gripped by the second holding part 19, and is movable by driving the second robotic arm 13B within the given operating range.

The abutting part 20 has two position regulating members 21. The position regulating members 21 are attached to a tip-end part of the abutting part 20 in a D2 direction from an attaching part 20a rotatably attached to the rotating part 42b of the wrist part 42 to the position regulating members 21.

The two position regulating members 21 are each formed in a stepped shape so that it is lowered gradually as it goes in the D2 direction. Moreover, in a D3 direction, the position regulating members 21 is each formed in a stepped shape so that it is lowered gradually as it goes toward the opposite position regulating member 21. Therefore, a protrusion 22 is formed in each of the two position regulating members 21, which protrudes toward the opposite position regulating member 21.

An upper surface (first abutting position) 22a of the protrusion 22 is horizontal in a state illustrated in FIG. 4. Therefore, the upper surfaces 22a of the protrusions 22 can function as the abutting position of the abutting part 20 (described later). The upper surfaces 22a of the protrusions 22 function as the abutting position in the gravity direction. Thus, the cable is abutted against the upper surfaces 22a of the protrusions 22 in the gravity direction.

Moreover, a side surface (second abutting position) 23 extending upward from an outer end part of the upper surface 22a in the D3 direction is formed at the position regulating member 21 in the state illustrated in FIG. 4. By pinching the workpiece between the two side surfaces 23 of the two position regulating members 21, positioning of the workpiece in the D3 direction can be performed. That is, the side surfaces 23 functions as the abutting position in the D3 direction. Thus, the cable is abutted against the side surfaces 23 in the width direction of the cable.

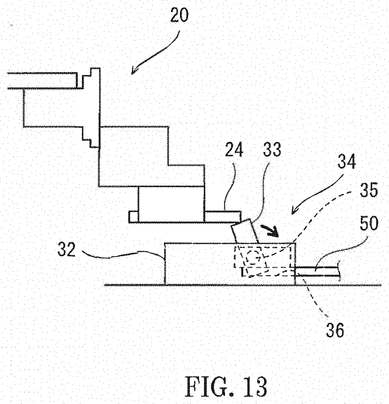

Moreover, the position regulating member 21 is provided with a contacting part 24 which contacts a lid part 33 of the connector 32 and moves the lid part 33 in a direction approaching to the connecting position when the cable is connected to the connector 32, which will be described later (FIG. 13).

The two position regulating members 21 provided to the abutting part 20 are movable to each other in the D3 direction (the width direction of the cable) perpendicular to the D2 direction in a horizontal plane. By the two position regulating members 21 moving to each other in the D3 direction, a distance between the two position regulating members 21 can be changed.

The two position regulating members 21 are connected to the same threaded shaft. Therefore, when moving the two position regulating members 21 in the D3 direction, the threaded shaft rotates in connection with the movement of the position regulating members 21. When the threaded shaft rotates, the position regulating members 21 are moved so that a moving amount of one of the position regulating members 21 and a moving amount of the other position regulating members 21 become the same. Moreover, at this time, one position regulating member 21 and the other position regulating member 21 move in the mutually opposite directions. Therefore, the two position regulating members 21 are disposed symmetrically to the center position in the D3 direction. Therefore, each of the two position regulating members 21 can move so that the distance between the two position regulating members 21 is changed across the center position in the D3 direction.

Moreover, the holding part 10 is attached to the first robotic arm 13A, and the abutting part 20 is attached to the second robotic arm 13B. The first robotic arm 13A and the second robotic arm 13B are connected to the base shaft 16, and are configured to be coaxial. Since the first robotic arm 13A and the second robotic arm 13B are configured to be rotatable on the base shaft 16, they are rotatable on the same axis. Therefore, the operating ranges where the holding part 10 and the abutting part 20 are operable can be wider. Moreover, since the holding part 10 and the abutting part 20 are configured as the hands of the connecting device main body 100 which are configured as the robots, the holding part 10 and the abutting part 20 can be moved within the respective operating ranges with sufficient accuracy by driving the robotic arms 13.

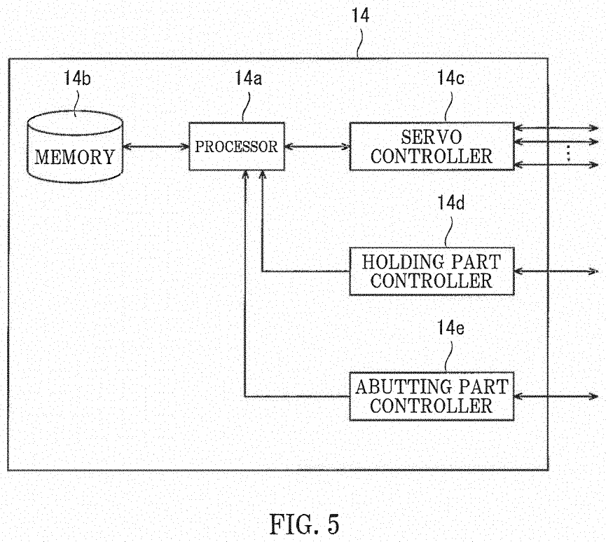

Next, the controller 14 which controls operation of the connecting device main body 100 is described. FIG. 5 is a block diagram schematically illustrating one example of a configuration of a control system of the connecting device main body 100. As illustrated in FIG. 5, the controller 14 includes a processor 14a, a memory 14b, a servo controller 14c, a holding part controller 14d, and an abutting part controller 14e.

The controller 14 is, for example, a robot controller provided with a computer, such as a microcontroller. Note that the controller 14 may be comprised of a sole controller 14 which carries out a centralized control, or may be comprised of a plurality of controllers 14 which collaboratively carry out a distributed control. The controller 14 may be comprised of circuitry, processing circuitry, a single circuitry or plural sub-circuits. Moreover, the sub-components of the controller 14 may be encompassed in or be comprised of separate circuitry.

The functionality of the elements disclosed herein including but not limited to the controller 14, processor 14a, memory 14b, servo controller 14c, holding part controller 14d and abutting part controller 14e. Such functionality and components may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The memory 14b stores information on a basic program as a robot controller, various fixed data, etc. The processor 14a controls various operations of the connecting device main body 100 by reading and executing software, such as the basic program stored in the memory 14b. That is, the processor 14a generates a control command for the connecting device main body 100, and outputs it to the servo controller 14c, the holding part controller 14d, and the abutting part controller 14e. For example, the processor 14a is comprised of a processor unit. [0068] The servo controller 14c controls the drive of the servomotors corresponding to the joints J1-J4 of the first robotic arm 13A and the second robotic arm 13B of the connecting device main body 100 based on the control command generated by the processor 14a.

The holding part controller 14d controls the suction, movement, and operation of the holding part 10 by controlling the vacuum generator and an actuator based on the control command generated by the processor 14a.

The abutting part controller 14e controls the movement of the position regulating members 21 of the abutting part 20, and the movement and operation of the abutting part 20 by controlling the actuator based on the control command generated by the processor 14a. [0071] Operation when connecting the cable 50 to the connector 32 of the substrate by using the connecting device 1 having the above configuration is described.

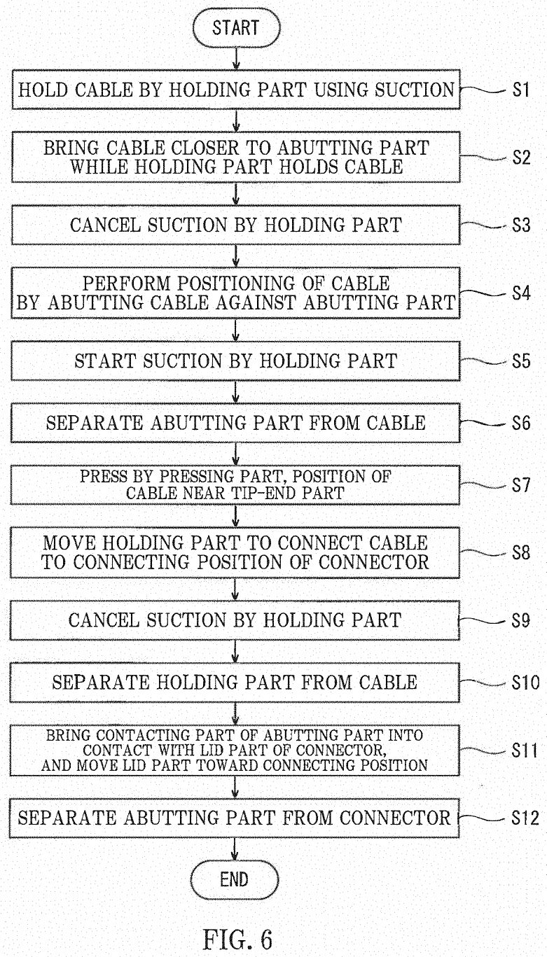

A flowchart illustrating a control flow when connecting the cable 50 to the connecting position of the connector 32 by using the connecting device 1 is illustrated in FIG. 6.

First, the holding part 10 moves toward the cable 50, and the holding part 10 holds the cable 50.

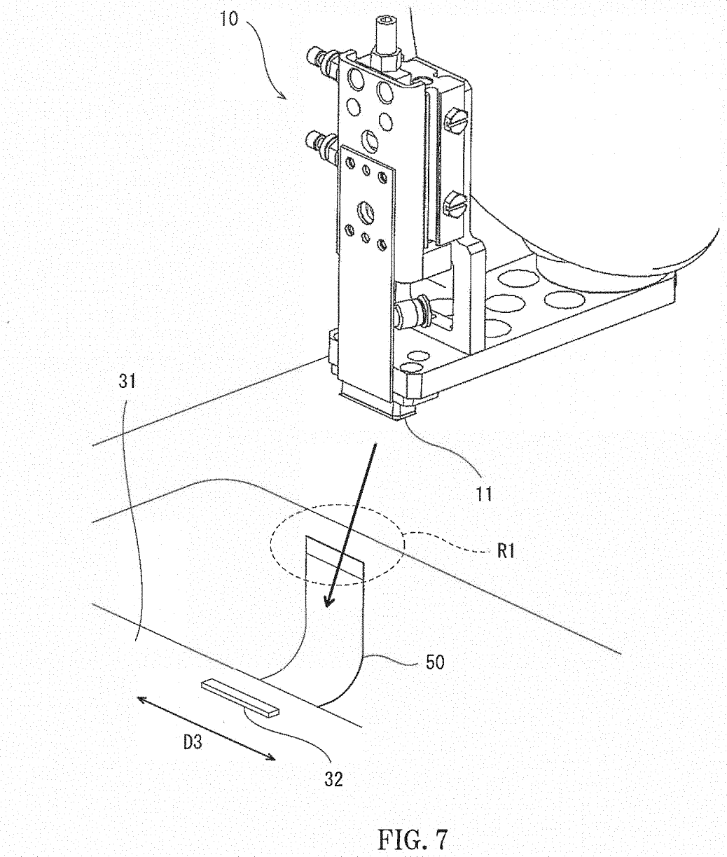

A perspective view of the holding part 10 and the cable 50 in a state where the holding part 10 moves toward the cable 50 in order to hold the cable 50 is illustrated in FIG. 7.

In the state illustrated in FIG. 7, the cable 50 is fixed at its base-end part to the substrate 31, and its tip-end part is freely movable without being restrained. At this time, since the cable 50 is fixed at the base-end part, an approximate range where the tip-end part of the cable 50 can be located is known. Here, a certain area where a part around the tip-end part of the cable 50 is estimated to be located is referred to as an estimated area R1.

In the state where the tip-end part of the cable 50 is not restrained, since the range where the tip-end part of the cable 50 is located falls within the certain estimated area R1, it can be considered that the holding part 10 contacts the part around the tip-end part of the cable 50, if the holding part 10 is moved so as to pass through the estimated area R1. By moving the holding part 10 so as to pass through the estimated area R1, the holding part 10 contacts the part around the tip-end part of the cable 50. In detail, the suction part 11 of the holding part 10 contacts the part around the tip-end part of the cable 50.

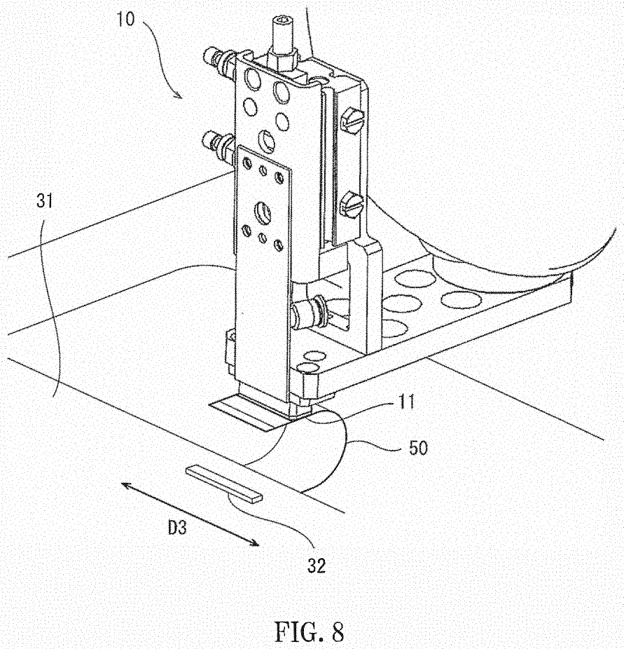

A perspective view of the holding part 10 and the cable 50 when the holding part 10 contacts the part around the tip-end part of the cable 50 is illustrated in FIG. 8.

Since the holding part 10 passes through the estimated area R1 and contacts the cable 50, the cable 50 is more bent than the state illustrated in FIG. 7 after the holding part 10 contacted the cable 50. At this time, since the holding part 10 presses the part around the tip-end part of the cable 50 downwardly with a force larger than an elastic force of the cable 50, the cable 50 is more bent, and the cable 50 contacts the suction part 11 of the holding part 10 in a state where the cable 50 is biased so as to resume the original shape.

Since the part around the tip-end part of the cable 50 is pressed downwardly by the suction part 11, and the suction part 11 is in contact with the cable 50, the holding part 10 can hold the cable 50 by performing the suction by the suction part 11 in this state. When the holding part 10 is brought into contact with the periphery of the tip-end part of the cable 50 when the holding part 10 passes through the estimated area R1, and the suction is performed by the suction part 11, the cable 50 is held by the holding part 10 as illustrated in FIG. 1 (S1) (First Holding Step). At this time, by performing the suction through the suction openings of the suction part 11 while the suction part 11 of the holding part 10 is in contact with the cable 50, the holding part 10 holds the cable 50 by suction. Note that the suction by suction openings of the suction part 11 may be performed in a phase before contacting the cable 50.

When the holding part 10 holds the cable 50, the holding part 10 and the abutting part 20 are moved to bring the holding part 10 and the abutting part 20 closer to each other. Therefore, while the holding part 10 holds the cable 50, the cable 50 is brought closer to the abutting part 20 (S2) (Approaching Step).

If the part around the tip-end part of the cable 50 is within the estimated area R1 in the state where the tip-end part of the cable 50 is not restrained, the position of the part around the tip-end part of the cable 50 after the cable 50 is held by the holding part 10 can also be determined approximately. That is, a spatial relationship between the position where the cable 50 is held by the holding part 10 and the abutting part 20 is known beforehand. Therefore, a moving path of the holding part 10 from the position where the part around the tip-end part of the cable 50 is held by the holding part 10 to the abutting part 20 can be determined. While the holding part 10 holds the part around the tip-end part of the cable 50, by moving the holding part 10 along the moving path, the tip-end part of the cable 50 can be brought closer to the abutting part 20. The tip-end part of the cable 50 is disposed at a position above the upper surfaces 22a of the protrusions 22 of the abutting part 20 in the gravity direction, and is disposed so as to be sandwiched between the two position regulating members 21 of the abutting part 20 in the width direction of the cable 50.

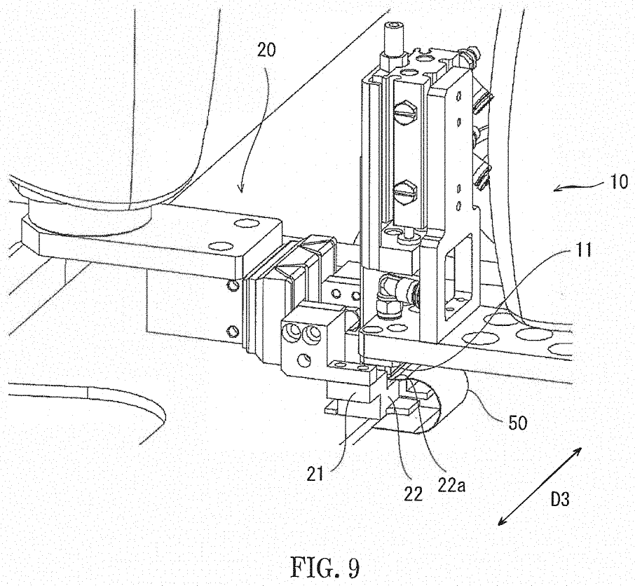

A perspective view of a periphery part of the holding part 10 and the abutting part 20, when the holding part 10 holding the cable 50 approaches the abutting part 20 is illustrated in FIG. 9.

As illustrated in FIG. 9, by the holding part 10 approaching the abutting part 20, the part of the cable 50 held by the holding part 10, which is sucked by the suction part 11 is disposed at a position between the two position regulating members 21. Therefore, the cable 50 and the position regulating members 21 are disposed with the spatial relationship in which the cable 50 is pinched between the two position regulating members 21 in the D3 direction which is the width direction of the cable 50. At this time, the cable 50 is disposed at the position above the upper surfaces 22a of the protrusions 22 of the position regulating members 21 in the gravity direction. Moreover, the cable 50 is disposed between the two side surfaces 23 of the position regulating members 21 which are provided vertically.

When the cable 50 is disposed at the position above the upper surfaces 22a of the protrusions 22 and is disposed at the position between the two position regulating members 21 in the D3 direction, the suction of the suction openings is then stopped so that the suction of the cable 50 by the suction part 11 of the holding part 10 is cancelled (S3) (First Hold Cancelling Step). Since the suction of the cable 50 by the suction part 11 is cancelled, the cable 50 is released and becomes in a freely movable state with respect to the holding part 10.

When the holding part 10 cancels the hold of the cable 50, the holding part 10 moves toward the abutting part 20 in the state where the cable 50 is disposed between the holding part 10 and the abutting part 20. By the holding part 10 contacting the abutting part 20 while pinching the cable 50, the cable 50 is abutted against the abutting part 20.

While the cable 50 is pinched between the holding part 10 and the abutting position of the abutting part 20, the holding part 10 is abutted against the abutting position of the abutting part 20 through the cable 50. Thus, the positioning of the cable 50 is performed by abutting the cable 50 against the abutting position of the abutting part 20 (S4) (Abutting Step). At this time, the cable 50 is abutted against the abutting part 20 in the state where the cable 50 is movable to the holding part 10.

The abutting part 20 is provided with the upper surfaces 22a of the protrusions 22 as the abutting position in the gravity direction. The upper surfaces 22a of the protrusions 22 extend substantially horizontally, and by the upper surfaces 22a of the protrusions 22 receiving the cable 50 from below, the cable 50 is abutted against the upper surfaces 22a of the protrusions 22. Since the upper surfaces 22a of the protrusions 22 extending horizontally receive the cable 50 from below, and the cable 50 is abutted against the upper surfaces 22a of the protrusions 22, the position in the gravity direction of the cable 50 can be regulated. Therefore, the positioning of the cable 50 in the gravity direction can be performed.

Moreover, the abutting part 20 is provided with the two position regulating members 21 which are movable in the D3 direction, and the position regulating members 21 are each provided with the side surface 23 which stands in the gravity direction. The side surfaces 23 are provided opposing to each other in the width direction D3 of the cable 50. The side surfaces 23 function as the abutting positions which perform the positioning of the cable 50 in the width direction D3. When abutting against the side surfaces 23, the two position regulating members 21 are moved toward each other, while the cable 50 is disposed between the two position regulating members 21.

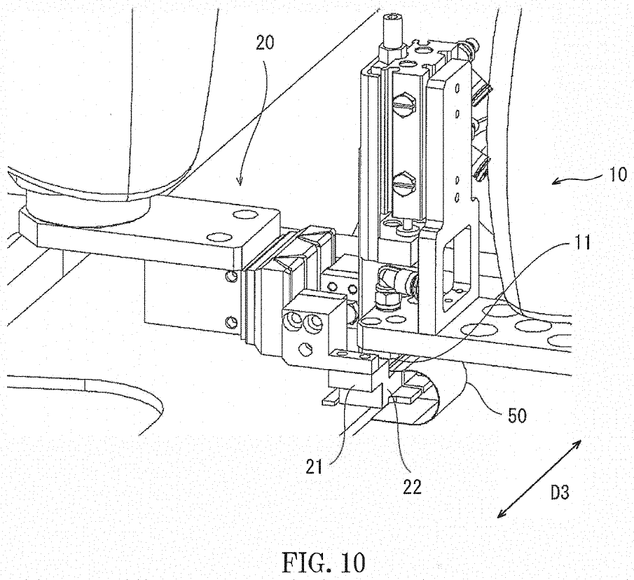

A perspective view of an area around the holding part 10 and the abutting part 20, when the two position regulating members 21 move toward each other, is illustrated in FIG. 10. By the two position regulating members 21 moving toward each other, the two position regulating members 21 can be in the state where their side surfaces 23 contact the cable 50 disposed between the side surfaces 23. That is, the cable 50 can be in a state where it is abutted against the side surfaces 23 of the position regulating members 21. By the cable 50 being abutted against the side surfaces 23 on both sides in the width direction D3, the position in the width direction D3 of the cable 50 can be regulated. Therefore, the positioning in the D3 direction of the cable 50 can be performed.

Thus, the side surfaces 23 which perform the positioning in the width direction of the cable 50 are movable in the width direction of the cable 50. The controller 14 controls the movement of the side surfaces 23, and particularly, the abutting part controller 14e controls the movement of the side surfaces 23.

When the cable 50 is abutted against the upper surfaces 22a of the protrusions 22 and the positioning of the cable 50 in the gravity direction is performed, and the cable 50 is abutted against the side surfaces 23 on the both sides in the width direction and the positioning of the cable 50 in the width direction is performed, the hold of the cable 50 by the holding part 10 is again started (S5) (Second Holding Step). At this time, by performing the suction through the suction openings while the suction part 11 of the holding part 10 contacts the cable 50, the holding part 10 holds the cable 50 by suction. Since the positioning of the cable 50 is performed before the suction of the cable 50 by the holding part 10 is performed at S5, the holding part 10 can hold the cable 50 at the given exact position when the cable 50 is held by the holding part 10 at S5. Moreover, since the holding part 10 holds the cable 50 by suction, it is reduced that a deviation occurs between the holding part 10 and the cable 50. Therefore, the holding part 10 can hold the cable 50 correctly at the positioning location.

When the holding part 10 holds the cable 50 for which the positioning is performed by abutting the cable 50 against the abutting positions of the abutting part 20, the abutting part 20 moves in a direction separating from the holding part 10 (S6).

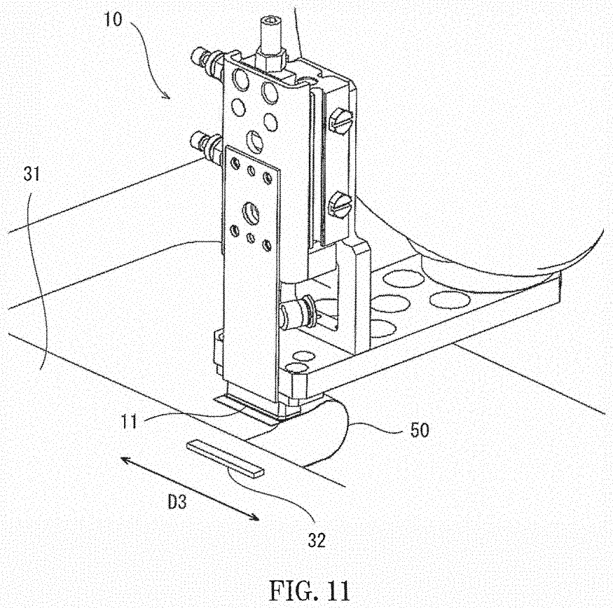

A perspective view of the holding part 10 in a state where the abutting part 20 is separated from the holding part 10 is illustrated in FIG. 11. In the state illustrated in FIG. 11, since it is after the cable 50 is positioned, the cable 50 is held by the holding part 10 correctly at the given position.

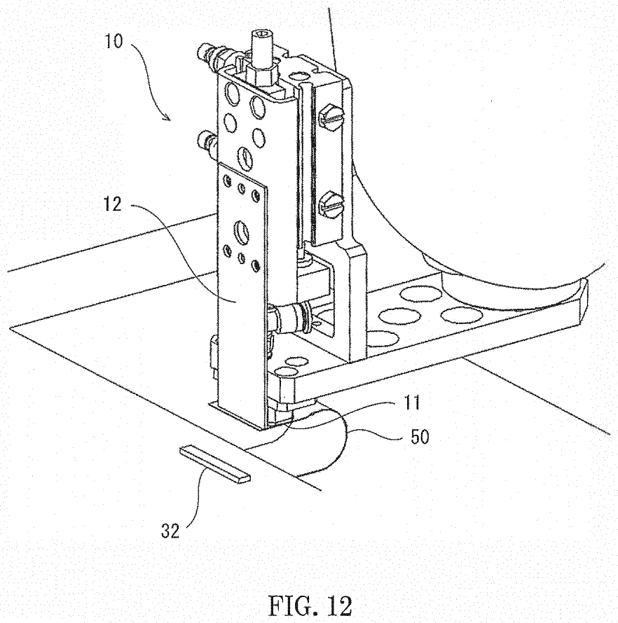

When the abutting part 20 separates from the holding part 10 and the abutting part 20 separates from the cable 50, the pressing part 12 descends and the pressing part 12 presses the position near the tip-end part of the cable 50 (S7). A perspective view of the holding part 10 in a state where the pressing part 12 descends and presses the tip-end part of the cable 50 is illustrated in FIG. 12.

Since an area closer to the tip-end part of the cable 50 than the holding position is pressed by the pressing part 12, a lift of the tip-end part of the cable 50 is suppressed, and the tip-end part of the cable 50 is disposed at a position with substantially the same height as the part sucked by the suction part 11. Therefore, the tip-end part of the cable 50 is disposed more correctly at the given position, and the tip-end part of the cable 50 is positioned more correctly.

When the cable 50 is held by the holding part 10, it is difficult to directly hold the tip-end part of the cable 50. A space needs to be secured in the tip-end part of the cable 50 for being inserted into the connector 32. Therefore, an area exists in the tip-end part of the cable 50 which is movable vertically without being held by the holding part 10. Since the area which is not held by the holding part 10 exists in the tip-end part of the cable 50, this area may float or rise when the cable 50 is sucked by the suction part 11. When the cable 50 is inserted into the connecting position of the connector 32 and the tip-end part of the cable 50 floats, the position of the tip-end part of the cable 50 may be deviated from the given position, and therefore, the cable 50 may be unable to be connected correctly to the connecting position of the connector 32.

The tip-end part of the cable 50 is correctly positioned because it is pressed by the pressing part 12. Therefore, the cable 50 can be securely connected to the connecting position of the connector 32. Since the holding part 10 is provided with the pressing part 12, it can suppress the occurrence of the lift of the tip-end part of the cable 50. Therefore, it can suppress the positional deviation of the tip-end part of the cable 50 due to the lift of the tip-end part of the cable 50, and therefore, the cable 50 can be securely connected to the connecting position.

The pressing of the cable 50 by the pressing part 12 is controlled by the controller 14 of the connecting device main body 100. The pressing of the cable 50 by the pressing part 12 is controlled by the holding part controller 14d of the controller 14.

When the pressing part 12 descends and the tip-end part of the cable 50 is pressed by the pressing part 12, the holding part 10 moves while holding the cable 50 to connect the cable 50 to the connecting position of the connector 32 (S8) (Connecting Step).

The cable 50 is correctly positioned at the given position by being abutted against the abutting part 20. Moreover, at this time, the spatial relationship between the holding position of the cable 50 by the holding part 10 and the connecting position of the connector 32 to the substrate 31 is known beforehand. Since the cable 50 is positioned correctly and the spatial relationship from the given position to the connecting position of the connector 32 is known, the cable 50 can be securely connected to the connector 32 by moving the cable 50 to the connecting position of the connector 32.

When the cable 50 is connected to the connecting position of the connector 32, the hold of the cable 50 by the holding part 10 is cancelled by cancelling the suction of the suction part 11 (S9) (Second Hold Cancelling Step).

When the hold of the cable 50 by the holding part 10 is cancelled, the holding part 10 separates from the cable 50 (S10).

Moreover, the connector 32 is provided with a lock mechanism 34 which maintains the connecting state when the cable 50 is connected to the connecting position. A side view of the connector 32 and the abutting part 20, when the lock mechanism 34 of the connector 32 is changed into a closed state from an open state, is illustrated in FIG. 13.

A connecting position 36 into which the cable 50 is inserted is formed in the connector 32. Moreover, the lid part 33 is attached to the connector 32 so as to be rotatable centering on a rotation shaft 35. The lid part 33 is movable from a position of the open state where the connecting position 36 is opened to a position of the closed state where the lid part 33 covers the connecting position 36. Therefore, the lid part 33 can be positioned in the open state where the connecting position 36 of the connector 32 is opened and the closed state where the connecting position 36 of the connector 32 is covered with the lid part 33. When the lid part 33 is in the open state, the cable 50 can be inserted into the connecting position 36 to connect the cable 50 to the connecting position 36.

Moreover, by rotating the lid part 33 centering on the rotation shaft 35 after the cable 50 is connected to the connecting position 36 in the open state of the lid part 33, the lid part 33 can changed into the closed state. When the lid part 33 is closed, the lid part 33 is restrained at the closed position. By the lid part 33 being restrained at the closed position, the state where the cable 50 is connected to the connecting position 36 can be maintained. Thus, the connector 32 can position the lid part 33 at the open state and the closed state, and it is provided with the lock mechanism 34 which maintains the connecting state of the cable 50 by changing the lid part 33 into the closed state while the cable 50 being inserted into the connecting position 36. By the lid part 33 moving closer to the connecting position 36 and becoming in the closed state, the connecting state of the cable 50 to the connecting position 36 can be maintained.

As illustrated in FIG. 13, by bringing the contacting part 24 of the abutting part 20 into contact with the lid part 33 of the connector 32 and moving the lid part 33 toward the connecting position 36, the lid part 33 can be changed into the closed state and the lock mechanism 34 can be locked (S11). Therefore, the connecting state of the cable 50 to the connecting position 36 can be maintained.

Moreover, since the abutting part 20 is provided with the contacting part 24 which contacts the lid part 33 and moves the lid part 33, the lid part 33 can be changed into the closed state by moving the abutting part 20. Therefore, by moving the abutting part 20, the connecting state where the cable 50 is connected to the connecting position 36 can be maintained. Therefore, with the simple configuration, the lid part 33 of the connector 32 can be moved to be in the closed state.

When the contacting part 24 of the abutting part 20 is brought into contact with the lid part 33 to move the lid part 33 so that the lid part 33 is changed into the closed state, the abutting part 20 separates from the connector 32 (S12). When the abutting part 20 separates from the connector 32, the connection of the cable 50 to the connector 32 by the connecting device 1 is finished.

According to the present disclosure, after the cable 50 is abutted against the abutting position of the abutting part 20 so that the positioning is performed, the cable 50 is connected to the connecting position 36 of the connector 32. Therefore, the cable 50 can be securely connected to the connecting position 36 of the connector 32.

Moreover, since the positioning is performed by abutting the cable 50 against the abutting position of the abutting part 20, the positioning can be performed with the simple configuration. Since the positioning is performed by abutting the cable 50 against the abutting position of the abutting part 20, it is not necessary to examine the positional deviation of the cable 50 in an image. Therefore, the imaging means, such as the camera, is not required. Since the imaging means is not required, the configuration of the connecting device 1 can be simplified. Therefore, the manufacturing cost of the connecting device 1 can be reduced. Moreover, since it is not necessary to recognize the positional deviation of the cable 50 based on the image etc., the configuration of the control system of the connecting device 1 can be simplified. Therefore, the manufacturing cost of the connecting device 1 can be further reduced. Moreover, since it is not necessary to correct the positional deviation of the workpiece, the configuration of the connecting device 1 can be further simplified.

Moreover, since it is not necessary to recognize the positional deviation of the cable 50 based on the image etc. to connect the positioned cable 50 to the connecting position, the connection of the cable 50 to the connecting position can be performed more quickly. Moreover, since it is not necessary to correct the positional deviation of the cable 50, the connection of the cable 50 to the connecting position can be performed more quickly. Therefore, an increased number of cables 50 can be connected per given time, and the connection of the cable 50 to the connecting position can be performed more efficiently.

Moreover, since the holding part 10 and the abutting part 20 may be configured as the hands of the robot, the holding part 10 and the abutting part 20 are configured to be movable. Therefore, by abutting the cable 50 against the abutting position of the abutting part 20 at the position close to the connector 32, the abutting part 20 can perform the positioning of the cable 50 at the position close to the connector 32. Since the positioning of the cable 50 is performed at the position close to the connector 32, the cable 50 which is positioned by being abutted against the abutting positions of the abutting part 20 and is held at the exact position is connected to the connector 32 while being held correctly. Therefore, the cable 50 can be connected to the connector 32 more securely. Moreover, since the positioning of the cable 50 is performed at the position close to the connector 32, the positioned cable 50 is immediately connected to the connector 32. Therefore, the cable 50 can be connected to the connector 32 at higher speed, and the cable 50 can be connected to the connector 32 more efficiently.

Note that the abutting part 20 does not perform the high-precision positioning in the D2 direction (FIG. 4) from the attaching part 20a rotatably attached to the rotating part 42b of the wrist part 42 to the position regulating members 21. Since the cable 50 is eventually connected to the connecting position 36 of the connector 32 by being pushed in the D2 direction, the high-accuracy positioning is not demanded in the D2 direction. Therefore, the positioning in the D2 direction is not performed in particular. However, the present disclosure is not limited to this configuration, and may perform the positioning in the D2 direction. For example, a side surface which stands vertically may be formed at an end part of the position regulating member 21 of the abutting part 20, which is closer to the attaching part 20a to the wrist part 42 in the D2 direction (FIG. 4), and the positioning in the D2 direction may be performed by abutting the cable 50 against the side surface.

Note that when the cable 50 is connected to the connecting position 36 of the connector 32, the contacting part 24 of the abutting part 20 is brought into contact with the lid part 33 to move the lid part 33 into the closed state, but the present disclosure is not limited to this configuration. The operation of changing the lid part 33 of the lock mechanism 34 into the closed state after the cable 50 is connected may not be necessarily performed. If the connecting state of the cable 50 to the connector 32 can be maintained even if the operation of changing the lid part 33 of the lock mechanism 34 into the closed state is not performed, the operation of changing the lid part 33 of the lock mechanism 34 into the closed state may not be performed.

According to a connecting device of the present disclosure, since the workpiece is positioned by being abutted against the abutting position of the abutting part is connected to the connecting position of the connecting part, the workpiece can be securely connected to the connecting position. Further, when connecting the workpiece, it is not necessary to recognize the positional deviation of the workpiece based on an image etc., and it is not necessary to correct the positional deviation of the workpiece, and therefore, the configuration of the connecting device can be simplified.

Moreover, the controller may move the holding part so that the holding part passes through an estimated area where a part around a tip-end part of the workpiece is estimated to be located, and the controller may control the holding of the workpiece by the holding part and the movement of the holding part so that, when the holding part passes through the estimated area, the holding part contacts the workpiece and holds the workpiece.

By the holding part passing through the estimated area where the part around the tip-end part of the workpiece is estimated to be located, the holding part is caused to hold the workpiece by contacting the workpiece. Thus, the holding part can securely hold the workpiece and the holding of the workpiece by the holding part can be performed efficiently.

Moreover, the abutting position may include a first abutting position against which the workpiece is abutted in the gravity direction.

Since the abutting position includes the first abutting position against which the workpiece is abutted in the gravity direction, the workpiece can be positioned with respect to the gravity direction.

Moreover, the abutting position may include a second abutting position against which the workpiece is abutted in a width direction of the workpiece.

Since the abutting position includes the second abutting position against which the workpiece is abutted in the width direction of the workpiece, the workpiece can be positioned with respect to the width direction of the workpiece.

Moreover, the second abutting position may be movable in the width direction of the workpiece, and the controller may control movement of the second abutting position.

Since the second abutting position is movable in the width direction of the workpiece, the workpiece can be abutted against the second abutting position by the second abutting position being moved. Therefore, the positioning of the workpiece in the width direction can be securely performed.

The holding part may hold the workpiece by suction. Since the holding part holds the workpiece by suction, the deviation between the holding part and the workpiece can be reduced and the workpiece can be held correctly at the positioning location.

The holding part may include a pressing part configured to press an area of the workpiece closer to a tip-end part than a holding position held by the holding part. The controller may control the pressing of the workpiece by the pressing part.

Since the holding part includes the pressing part configured to press the area of the workpiece closer to the tip-end part than the holding position, it can suppress occurrence of a lift of the tip-end part of the workpiece. Therefore, it can suppress the positional deviation of the workpiece due to the lift of the tip-end part of the workpiece, and therefore, the workpiece can be securely connected to the connecting position.

The connecting part may include a connecting position into which the workpiece is inserted, and a lid part movable between a position where the connecting position is opened and a position where the connecting position is covered. The abutting part may include a contacting part configured to move the lid part to the position where the connecting position is covered, by contacting the lid part when the workpiece is inserted into the connecting position.

Since the abutting part includes the contacting part configured to move the lid part to the position where the connecting position is covered, by contacting the lid part when the workpiece is inserted into the connecting position, the lid part can be brought into the state where it covers the connecting position by moving the abutting part. Therefore, the lid part can be brought into the state where it covers the connecting positions with a simple configuration.

The holding part and the abutting part may be each configured as a hand of a robot.

Since the holding part and the abutting part are each configured as the hand of the robot, the holding part and the abutting part can be each accurately moved within a given operating range by driving a robotic arm.

The robot may have a first arm and a second arm. The holding part may be attached to the first arm. The abutting part may be attached to the second arm. The first arm and the second arm may be rotatable on the same axis.

Since the holding part is attached to the first arm, the abutting part is attached to the second arm, and the first arm and the second arm are rotatable on the same axis, the operating ranges where the holding part and the abutting part are operable can be wider.

Moreover, a connecting method according to the present disclosure is a method of connecting a workpiece to a connecting position using a connecting device including a holding part configured to hold the workpiece and an abutting part against which the workpiece held by the holding part is abutted, the workpiece being elongated, having flexibility, and fixed at a base-end part thereof. The method includes the steps of holding the workpiece by the holding part, bringing the held workpiece closer to the abutting part, cancelling the holding of the workpiece by the holding part at the position closer to the abutting part, abutting against the abutting part the workpiece for which the holding by the holding part is cancelled, holding by the holding part the workpiece abutted against the abutting part, connecting to a connecting part the workpiece held by the holding part, and cancelling the holding by the holding part of the workpiece connected to the connecting part.

According to the connecting method with this configuration, since the workpiece which is positioned by being abutted against the abutting part in the abutting is connected to the connecting position in the connecting, the workpiece can be securely connected to the connecting position. Further, when connecting the workpiece, it is not necessary to recognize the positional deviation of the workpiece based on an image etc., and it is not necessary to correct the positional deviation of the workpiece, and therefore, the required configuration of the device can be simplified.

Moreover, when the holding part first holds the workpiece, the holding part may pass through an estimated area where a part around a tip-end part of the workpiece is estimated to be located, and the holding part may contact the workpiece and holds the workpiece.

Since the holding part is caused to hold the workpiece by contacting the workpiece by passing through the estimated area where the part around the tip-end part of the workpiece is estimated to be located, the holding part can securely hold the workpiece and the holding of the workpiece by the holding part can be performed efficiently.

According to the present disclosure, the workpiece can be securely connected to the connecting position with the simple configuration and, thus, a manufacturing cost of the connecting device in which the workpiece is securely connected to the connecting position, can be reduced.

### REFERENCE CHARACTERS

J1-J4 Rotary joint

L1-L3 Rotation axis

R1 Estimated area

1 Connecting Device

10 Holding Part

10a Attaching part

11 Suction part

12 Pressing Part

13A First robotic arm

13B Second robotic arm

14 Controller

14a Processor

14b Memory

14c Servo controller

14d Holding part controller

14e Abutting part controller

15 Support

16 Base shaft

18 First holding part

19 Second holding part

20 Abutting Part

21 Position Regulating Member

22 Protrusion

22a Upper Surface (First Abutting Position)

23 Side Surface (Second Abutting Position)

24 Contacting part

30 Table

30 Substrate

32 Connector (Connecting Part)

33 Lid Part

34 Lock Mechanism

35 Rotation shaft

36 Connecting Position

41 Arm part

41a First link

41b Second link

42 Wrist part

42a Elevating part

42b Rotating part

50 Cable

100 Connecting device main body

1. A connecting device configured to connect a workpiece to a connector, wherein the workpiece is fixed at a base-end part of the workpiece, the connecting device comprising:
a holding part configured to hold the workpiece;
an abutting part against which the workpiece is abutted; and
processing circuitry configured to control the holding part to hold the workpiece, control movement of the holding part, and control movement of the abutting part, wherein
the processing circuitry controls the holding part and the abutting part so that the holding part holds the workpiece abutted against an abutting position of the abutting part and so that the workpiece is connected to the connector.

2. The connecting device of claim 1, wherein
the processing circuitry controls the holding part to move so that the holding part passes through an estimated area where a part around a tip-end part of the workpiece is estimated to be located, and
the processing circuitry controls the holding part so that, when the holding part passes through the estimated area, the holding part contacts the workpiece and holds the workpiece.

3. The connecting device of claim 1, wherein the abutting position includes a first abutting position against which the workpiece is abutted in a direction of gravity.

4. The connecting device of claim 1, wherein the abutting position includes a second abutting position against which the workpiece is abutted in a width direction of the workpiece.

5. The connecting device of claim 4, wherein
the second abutting position is movable in the width direction of the workpiece, and
the processing circuitry controls movement of the second abutting position.

6. The connecting device of claim 1, wherein the holding part holds the workpiece by suction.

7. The connecting device of claim 1, wherein
the holding part includes a pressing part configured to press an area of the workpiece closer to a tip-end part of the workpiece than a holding position held by the holding part, and
the processing circuitry controls the pressing part to press the workpiece.

8. The connecting device of claim 1, wherein
the connector includes a connecting position into which the workpiece is inserted, and a lid part movable between a position where the connecting position is opened and a position where the connecting position is covered, and
the abutting part includes a contacting part configured to move the lid part to the position where the connecting position is covered, by contacting the lid part when the workpiece is inserted into the connecting position.

9. The connecting device of claim 1, wherein the holding part and the abutting part are each configured as a hand of a robot.

10. The connecting device of claim 9, wherein
the robot has a first arm and a second arm,
the holding part is attached to the first arm,
the abutting part is attached to the second arm, and
the first arm and the second arm are rotatable on a same axis.

11. A method of connecting a workpiece to a connector using a connecting device that includes a holding part configured to hold the workpiece, an abutting part against which the workpiece is abutted, and processing circuitry, wherein the workpiece is fixed at a base-end part of the workpiece, the method comprising:
controlling, by the processing circuitry, the holding part to hold the workpiece;
moving, by the processing circuitry, the holding part to be closer to the abutting part;
controlling the holding part to cancel holding of the workpiece at the position closer to the abutting part;
moving, by the processing circuitry, the abutting part to be positioned so as to abut the workpiece;
holding, by the holding part, the workpiece abutted against the abutting part;
connecting the workpiece to the connector; and
controlling the holding part to cancel holding of the workpiece connected to the connecting part.

12. The method of claim 11, wherein, when the holding part first holds the workpiece, the holding part passes through an estimated area where a part around a tip-end part of the workpiece is estimated to be located, and the holding part contacts the workpiece and holds the workpiece.

13. The method of claim 11, wherein the abutting position includes a first abutting position against which the workpiece is abutted in a direction of gravity.

14. The method of claim 11, wherein the abutting position includes a second abutting position against which the workpiece is abutted in a width direction of the workpiece.

15. The method of claim 14, wherein the second abutting position is movable in the width direction of the workpiece.

16. The method of claim 1, wherein the holding part holds the workpiece by suction.

17. The method of claim 11, wherein
the holding part includes a pressing part configured to press an area of the workpiece closer to a tip-end part of the workpiece than a holding position held by the holding part, and
the method further comprises pressing the workpiece by the pressing part.

18. The method of claim 11, wherein
the connector includes a connecting position into which the workpiece is inserted, and a lid part movable between a position where the connecting position is opened and a position where the connecting position is covered, and
the abutting part includes a contacting part configured to move the lid part to the position where the connecting position is covered, by contacting the lid part when the workpiece is inserted into the connecting position.

19. A robot configured to connect a workpiece to a connector, wherein the workpiece is fixed at a base-end part of the workpiece, the robot comprising:
a first hand;
a second hand; and
processing circuitry configured to control movement of the first hand and the second so that the first hand holds the workpiece and the second hand abuts the workpiece, wherein
the first hand holds the workpiece so that the workpiece is abutted against an abutting position of the second hand and so that the workpiece is connected to the connector.

20. The robot of claim 19, wherein
the processing circuitry controls the first hand to move so that the first hand passes through an estimated area where a part around a tip-end part of the workpiece is estimated to be located, and
the processing circuitry controls the first hand so that, when the first hand passes through the estimated area, the first hand contacts the workpiece and holds the workpiece.
